(19) United States
(12) Patent Application Publication
(10) Pub. No.: US 2024/0228226 A1
(43) Pub. Date: Jul. 11, 2024

(54) ELEVATOR COMMUNICATION SYSTEM

(71) Applicant: KONE Corporation, Helsinki (FI)

(72) Inventors: Ari JUSSILA, Helsinki (FI); Ari KATTAINEN, Helsinki (FI)

(73) Assignee: KONE Corporation, Helsinki (FI)

(21) Appl. No.: 18/618,066

(22) Filed: Mar. 27, 2024

Related U.S. Application Data
(63) Continuation of application No. PCT/EP2021/079669, filed on Oct. 26, 2021.

(51) Int. Cl. B66B 1/34; H04L 12/403

(52) U.S. Cl. CPC B66B 1/3453; B66B 1/3438; H04L 12/403

(57) ABSTRACT

According to an aspect, there is provided an elevator communication system including a communication bus applying a master-slave protocol, a master node connected to the communication bus and at least one slave node connected to the communication bus. The master node and the at least one slave node are configured to apply, for data communication in the communication bus, a repeating frame structure in which a first time slot of a frame is reserved for the master node and in the remaining time slots of the frame each slave node of the at least one slave node has a dedicated time slot. The master node is configured to extend the time between consecutive frames in order to enable a power saving mode for the communication bus.

### TECHNICAL FIELD

The present application relates to the field of elevator communication systems.

### BACKGROUND

In an elevator system, data needs to be communicated between various entities within the elevator system. For safety related data there are certain requirements that need to be met.

The safety related data may be communicated using a communication bus that is based on master-slave communication. In the master-slave communication bus there is a master node and one or more slave nodes which communicate, for example, using serial communication.

When an elevator is in an idle or a standby mode, some power saving may be performed, for example, within individual circuit boards. This, however, does not provide any power saving actions in the communication bus.

It would be beneficial to have a solution that would alleviate at least one of these drawbacks.

### SUMMARY

According to a first aspect, there is provided an elevator communication system comprising a communication bus applying a master-slave protocol, a master node connected to the communication bus and at least one slave node connected to the communication bus. The master node and the at least one slave node are configured to apply, for data communication in the communication bus, a repeating frame structure in which a first time slot of a frame is reserved for the master node and in the remaining time slots of the frame each slave node of the at least one slave node has a dedicated time slot. The master node is configured to extend the time between consecutive frames in order to enable a power saving mode for the communication bus.

In an implementation form of the first aspect, the first time slot is preceded by a frame synchronization comprising idle bytes and a master node identifier byte, and the master node is configured to increase the number of idle bytes in the frame synchronization in order to enable the power saving mode.

In an implementation form of the first aspect, the master node is configured to receive from an elevator controller a command to enter the power saving mode.

In an implementation form of the first aspect, the at least one slave node is configured to enter the power saving mode when a duration between consecutive frames exceeds a predetermined threshold.

In an implementation form of the first aspect, the master node is configured to read at least one of its safety inputs, determine a change in at least one read the safety input; and re-initiate data communication via the communication bus in response to determining the change.

In an implementation form of the first aspect, a slave node is configured to: read at least one its safety input; determine a change in at least one read safety input; and transmit an indication associated with the change to the master node in order to re-initiate data communication via the communication bus; and the master node is configured to re-initiate data communication via the communication bus in response to the indication. In an implementation form of the first aspect, the communication bus comprises an ethernet communication bus.

In an implementation form of the first aspect, the ethernet communication bus comprises at least one of: one or more point-to-point ethernet bus segments; or one or more multi-drop ethernet bus segments.

In an implementation form of the first aspect, the point-to-point ethernet bus segment comprises 100BASE-TX or 10BASETIL point-to-point ethernet bus segment, and the multi-drop ethernet bus segment comprises a 10BASE-T1S multi-drop ethernet bus segment.

According to a second aspect, there is provided an elevator system comprising the elevator communication system of the first aspect.

According to a third aspect, there is provided a method comprising applying, by a master node and at least one slave node, a master-slave protocol in a communication bus between the master node and the at least one slave node, wherein the master node and the at least one slave node are configured to apply, for data communication in the communication bus, a repeating frame structure in which a first time slot of a frame is reserved for the master node and in the remaining time slots of the frame each slave node of the at least one slave node has a dedicated time slot; and extending, by the master node, the time between consecutive frames in order to enable a power saving mode for the communication bus.

In an implementation form of the third aspect, the first time slot is preceded by a frame synchronization comprising idle bytes and a master node identifier byte, and the method further comprises increasing, by the master node, the number of idle bytes in the frame synchronization in order to enable the power saving mode.

In an implementation form of the third aspect, the method further comprises receiving, by the master node, from an elevator controller a command to enter the power saving mode.

In an implementation form of the third aspect, the method further comprises reading, by the master node, at least one of its safety inputs; determining, by the master node, a change in at least one read safety inputs; and re-initiating, by the master node, data communication via the communication bus in response to determining the change.

In an implementation form of the third aspect, the method further comprises reading, by a slave node, at least one its safety input; determining, by the slave node, a change in at least one read safety input; transmitting, by the slave node, an indication associated with the change to the master node in order to re-initiate data communication via the communication bus; and re-initiating, by the master node, data communication via the communication bus in response to the indication.

According to a fourth aspect, there is provided a master node comprising means for applying a master-slave protocol in a communication bus between the master node and at least one slave node, wherein the master node and the at least one slave node are configured to apply, for data communication in the communication bus, a repeating frame structure in which a first time slot of a frame is reserved for the master node and in the remaining time slots of the frame each slave node of the at least one slave node has a dedicated time slot; and means for extending the time between consecutive frames in order to enable a power saving mode for the communication bus.

In an implementation form of the fourth aspect, the first time slot is preceded by a frame synchronization comprising idle bytes and a master node identifier byte, and the master node comprises means for increasing the number of idle bytes in the frame synchronization in order to enable the power saving mode.

In an implementation form of the fourth aspect, the master node comprises means for receiving from an elevator controller a command to enter the power saving mode.

In an implementation form of the fourth aspect, the master node comprises means for reading at least one of its safety inputs; means for determining a change in at least one read safety input; and means for re-initiating data communication via the communication bus in response to determining the change.

In an implementation form of the fourth aspect, the master node comprises means for receiving, from a slave node, an indication associated with a change of at least safety input of the slave node; and means for re-initiating data communication via the communication bus in response to the indication.

According to a fifth aspect, there is provided a computer program comprising program code, which when executed a master node, causes the master node of the fourth aspect to perform the method of the third aspect.

According to a sixth aspect, there is provided a computer-readable medium comprising a computer program comprising program code, which when executed a master node, causes the master node of the fourth aspect to perform the method of the third aspect.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates an elevator communication system according to an example embodiment.

FIG. 2 illustrates a frame structure used in a master-slave communication bus in an elevator system according to an example embodiment.

FIG. 3 illustrates a method according to an example embodiment.

FIG. 4 illustrates a master node according to an example embodiment.

FIG. 5A illustrates an elevator communication system according to an example embodiment.

FIG. 5B illustrates an elevator communication system according to another example embodiment.

### DETAILED DESCRIPTION

The following description illustrates a solution for power saving in an elevator system communication bus. The term “communication bus” used herein may refer to any communication bus implementation that uses master-slave type of communication in which each node connected to the bus may have a dedicated time slot for data transmission. Further, although the examples and embodiments below illustrate an elevator communication system, the solution may be applied also to a communication system of an escalator or a moving walk.

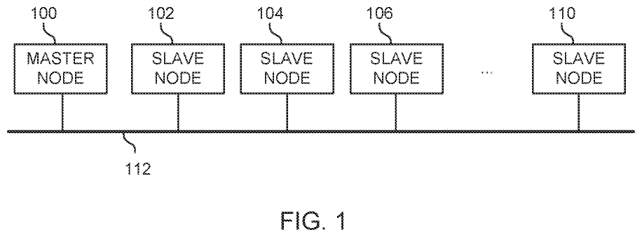

FIG. 1 illustrates an elevator communication system according to an example embodiment. The system comprises a master node 100 and at least one slave node 102-110. Each node is connected to a communication bus 112. Communication in the communication bus 112 may be implemented using serial data communication in which each node has a dedicated time slot for its data transmission. This enables a system in which each node has an equal opportunity to send data via the communication bus 112.

In an example embodiment, the communication bus may be a safety bus used in an elevator system. The same principle discussed herein, however, may be used in any master-slave communication system and, for example, in case of diagnostics messaging of other communication protocols, for example, a location operating network (LON) and a time critical ethernet based communication.

In an example embodiment, the master node may comprise a master safety node and the slave nodes may comprises various safety nodes.

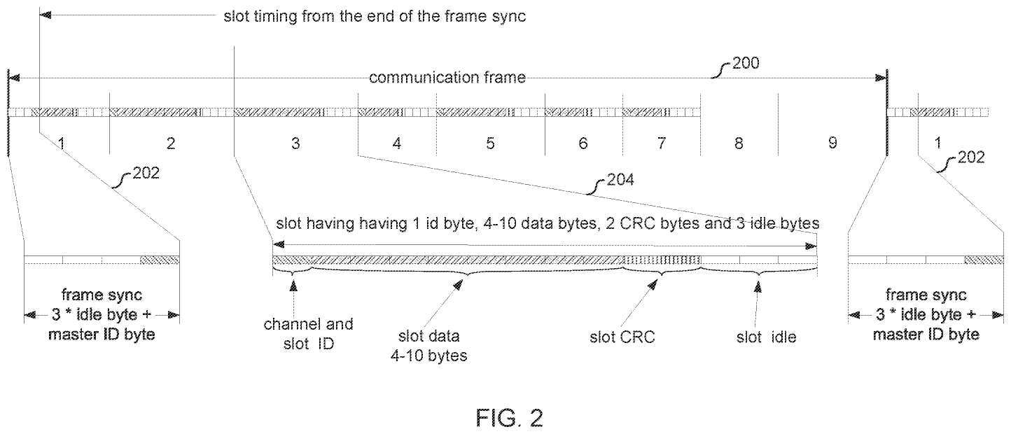

FIG. 2 illustrates a frame structure used in a master-slave communication bus in an elevator system according to an example embodiment. In this example embodiment, nodes are configured to transmit safety relevant data in a communication frame 200 which is repeated, for example, in every 16 ms. In other example embodiments, a different type of data may be transmitted and a different frame repetition interval may be used.

In this example embodiment, the frame starts with frame synchronization 202 that includes three idle bytes and a master node identifier. Time slot timing starts from the end of the frame synchronization. Each node 100-110 responds to the frame synchronization 202 by sending their data during a dedicated (i.e. node specific) time slot. The time slot 1 is dedicated to the master node 100 and the time slots 2-9 are dedicated to the slave nodes 102-110.

An example structure of a time slot is provided for the third time slot 204. The first byte may provide a channel and slot identifier. This is followed by 4-10 data bytes. After the data bytes two cyclic redundancy check (CRC) bytes may be provided. Three idle bytes follow the CRC bytes. After the ninth time slot, the frame synchronization is provided again followed by the time slots 1-9.

When an elevator is in an idle or a standby mode, some power saving may be performed within individual circuit boards. This, however, may not apply to communication buses. This may mean that the power saving actions does not have an effect on the communication buses. Further, normally energy saving is typically achieved, for example, by reading safety inputs with longer intervals during the idle mode and even disconnecting safety input power supplies during the standby mode.

In order to enable energy savings with the communication bus, the master node 100 may be configured to extend the time between consecutive frames 200 in order to enable a power saving mode for the communication bus 112. This may be implemented, for example, so that the first time slot is preceded by frame synchronization 202 comprising idle bytes and a master node identifier byte as illustrated in FIG. 2. Then, the master node 100 may be configured to increase the number of idle bytes in the frame synchronization in order to enable the power saving mode. The temporal length of the power saving mode may thus be controlled by the amount of idle bytes in the frame synchronization. This means that due to the extension of the idle byte amount, no traffic is transmitted in the communication bus 112.

In an example embodiment, the master node 100 may be configured to determine, when to enter the power saving mode. In another example embodiment, the master node 100 may obtain an external trigger or a command to enter the power saving mode. The external trigger may be received, for example, from an elevator controller.

In an example embodiment, the slave nodes 102-110 may be configured to enter the power saving mode when a duration between consecutive frames a exceeds predetermined threshold. This means that the slave nodes 102-110 do not have to receive any indication from the master node 100 about the length of the power saving mode. When the predetermined threshold is reached, the slave nodes 102-100 are able to deduct that the power saving mode is being applied.

In an example embodiment, the master node 100 may be configured to read at least one of its safety input, determine a change in at least one of the safety inputs, and re-initiate data communication via the communication bus 112 in response to determining the change. The power saving mode may then be ended by transmitting the master identifier byte.

In an example embodiment, a slave node 102-110 may be configured to read at least one its safety input, determine a change in at least one read safety input, and transmit an indication associated with the change to the master node 100 in order to re-initiate data communication via the communication bus 112. The master node 110 may be configured to re-initiate data communication via the communication bus 112 in response to the indication. When being in an idle or sleep mode, one or more of the slaves nodes 102-110 may not be in a complete or full idle mode/sleep mode. These slave nodes may comprise, for example, safety critical nodes, that are able to monitor their inputs, for example, less frequently in order to save energy. Thus, a safety node is able to revive the master node from the idle or sleep mode. This enable a solution that safety critical events can be detected even in the idle or sleep mode.

In an example embodiment, a slave node may be configured to be in an sleep mode. Let's assume that the slave node using the fifth time slot is in the sleep mode. In the sleep mode, the slave node may be configured to receive the first time slot from the master node 100, then not to process the time slots 2-4, transmit in its own time slot (time slot 5), and then again not to process the time slots 6-9. By doing this, the slave is able to save energy as it discards the time slots 2-4 and 6-9.

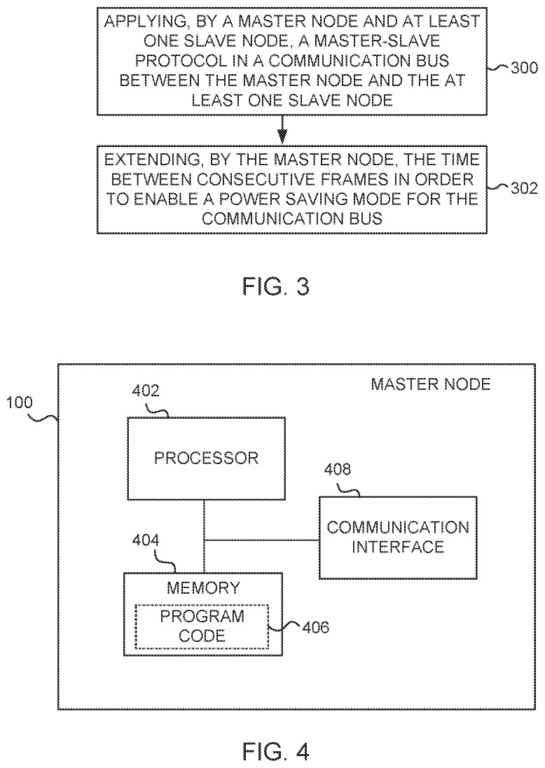

FIG. 3 illustrates a method according to an example embodiment.

At 300, a master node 100 may apply a master-slave protocol in a communication bus 112 between the master node 100 and at least one slave node 102-110. The master node 100 and the at least one slave node 102-110 are configured to apply, for data communication in the communication bus 112, a repeating frame structure in which a first time slot of a frame is reserved for the master node 100 and in the remaining time slots of the frame each slave node 102-110 of the at least one slave node 102-110 has a dedicated time slot. The data structure has been discussed in more detail above in relation to FIG. 2.

At 302 the master node 100 may extend the time between consecutive frames in order to enable a power saving mode for the communication bus 112. In an example embodiment, the first time slot is preceded by a frame synchronization that comprises idle bytes and a master node identifier byte. The master node 100 may then increase the number of idle bytes in the frame synchronization in order to enable the power saving mode. The temporal length of the power saving mode may thus be controlled by the amount of idle bytes in the frame synchronization.

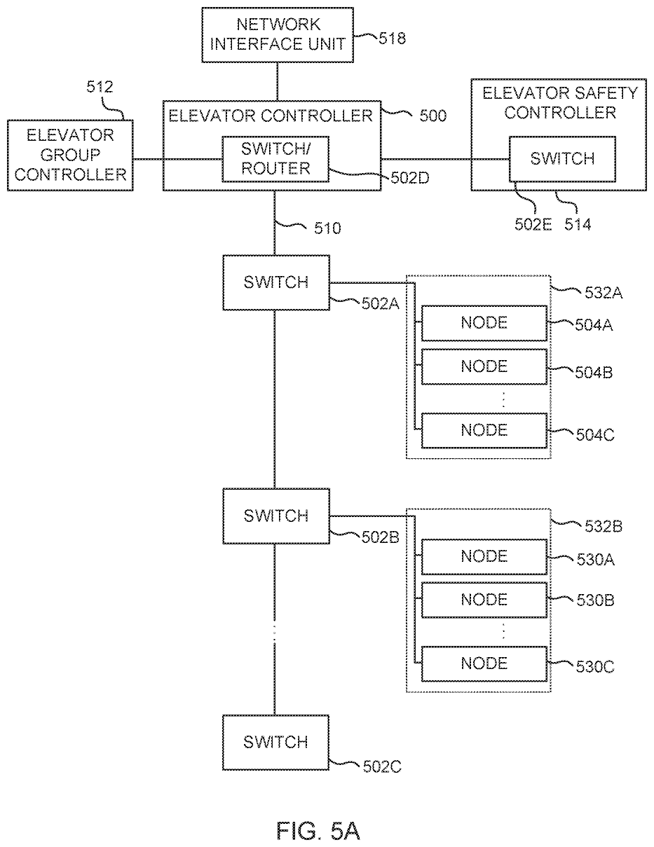

FIG. 4 illustrates a master node 100 according to an example embodiment. The master node 100 may be, for example, a safety node of an elevator system. The master node 100 may comprise at least one processor 402. The master node 100 may further comprise at least one memory 404. The memory 404 may comprise program code 406 which, when executed by the processor 402 causes the master node 100 to perform at least one example embodiment. The exemplary embodiments and aspects of the subject-matter can be included within any suitable device, for example, including, servers, elevator nodes, elevator controllers, workstations, capable of performing the processes of the exemplary embodiments. The exemplary embodiments may also store information relating to various processes described herein. Although the master node 100 is illustrated as a single device it is appreciated that, wherever applicable, functions of the master node 100 may be distributed to a plurality of devices.

Example embodiments may be implemented in software, hardware, application logic or a combination of software, hardware and application logic. The example embodiments can store information relating to various methods described herein. This information can be stored in one or more memories 404, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The processor 402 may comprise one or more general purpose processors, microprocessors, digital signal processors, micro-controllers, and the like, programmed according to the teachings of the example embodiments, as will be appreciated by those skilled in the computer and/or software art (s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art (s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 404 for holding instructions programmed according to the teachings for and holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The master node 100 may comprise a communication interface 408 configured to enable the processor 402 to transmit and/or receive information, to/from other apparatuses and/or elements associated with an elevator system.

The master node 100 may comprise means for performing at least one method discussed herein. In one example, the means may comprise the at least one processor 402, the at least one memory 404 including program code 406 configured to, when executed by the at least one processor 402, cause the master node 100 to perform the method discussed herein.

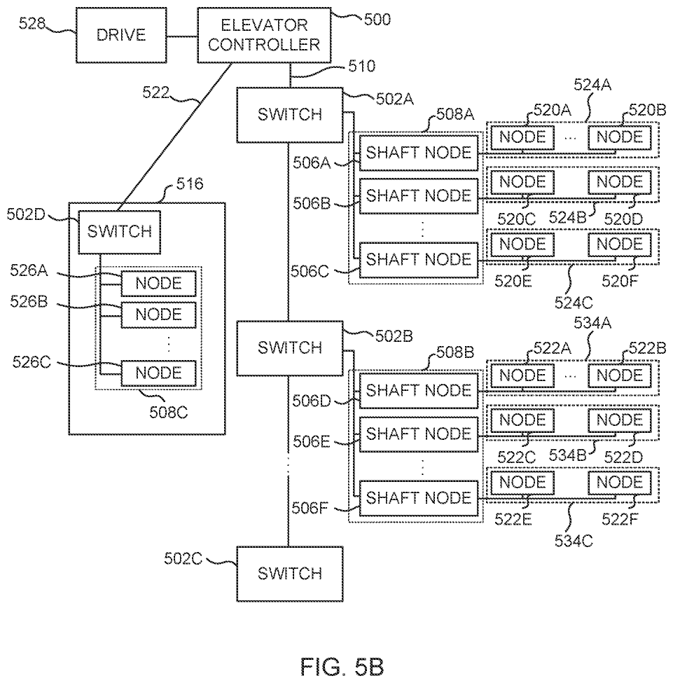

FIG. 5A illustrates an elevator communication system according to an example embodiment. The elevator communication system comprises an elevator controller 500. The elevator communication system may further comprise one or more multi-drop ethernet bus segments 532A, 532B reachable by the elevator controller 500, and a plurality of elevator system nodes 504A, 504B, 504C, 530A, 530B, 530C configured to communicate via the multi-drop ethernet bus segments 532A, 532B, wherein the elevator controller 500 is reachable by the elevator system nodes 504A, 504B, 504C via the multi-drop ethernet bus segments 532A, 532B. The elevator communication system may also comprise an elevator group controller 512 connected to the elevator controller 500. The elevator controller 500 may comprise a switch or a router 502D, which connects the elevator controller 500 to an internal ethernet network of the elevator communication system.

In an example embodiment, the elevator communication system may comprise a point-to-point ethernet bus 510 and at least one connecting unit 502A, 502B, 502C comprising a first port connected to the respective multi-drop ethernet bus segment 532A, 532B and a second port connected to the point-to-point ethernet bus 510. Thus, by using the connecting units 502A, 502B, 502C, one or more multi-drop ethernet bus segments 532A, 532B may be connected to the point-to-point ethernet bus 510. The connecting unit 502A, 502B, 502C may refer, for example, to a switch, a hub or a router. Further, the point-to-point ethernet bus 510 may be connected to the elevator controller 500. The point-to-point ethernet bus 510 may be, for example, 100BASE-TX or 10BASETIL point-to-point ethernet bus. The multi-drop ethernet bus segment 532A, 532B may comprise, for example, 10BASE-T1S multi-drop ethernet bus.

In an example embodiment, an elevator system node 504A, 504B, 504C, 530A, 530B, 530C may be configured to interface with at least one of an elevator fixture, an elevator sensor, an elevator safety device, and an elevator control device. Further, in an example embodiment, power to the nodes may be provided with the same cabling. In another example embodiment, the elevator system nodes 504A, 504B, 504C, 530A, 530B, 530C may comprise shaft nodes, and a plurality of shaft node may form a shaft segment, for example, the multi-drop ethernet bus segment 532A, 532B.

The elevator communication system may comprise an elevator safety controller 514. The elevator safety controller 514 may be connected to the point-to-point ethernet bus 510 via a connecting unit 502E. This means that the elevator system nodes 504A, 504B, 504C, 530A, 530B, 530C may send information to the elevator safety controller 514 and vice versa via the common point-to-point ethernet bus 510. For example, the elevator system nodes 504A, 504B, 504C, 530A, 530B, 530C may send information from sensors or fixtures to the elevator controller 500 or the elevator safety controller 514 and receive information therefrom to control, for example, actuators configure fixtures etc. At least some of the elevator system nodes 504A, 504B, 504C, 530A, 530B, 530C may be safety nodes in accordance with IEC61508 SIL level 3, having a safety processing unit and a separate communication controller. Data of the safety processing unit may be sent only to the elevator safety controller 514. The safety nodes may be configured to interface with elevator safety devices, such as safety sensors or safety contacts indicating elevator safety, e.g. landing door contacts, door lock contacts, contact of overspeed governor, buffer contacts etc. The safety nodes may be configured to communicate with the elevator safety controller 514. To establish safe communication, different kind of data checks, such as checksums, error detection and/or correction algorithms etc. may be used in the communication.

In an example embodiment, one of more of the nodes 504A-504C, 5532A-532C may act as a slave node or a master node.

FIG. 5B illustrates an elevator communication system according to another example embodiment. The elevator communication system comprises an elevator controller 500. The elevator communication system may further comprise one or more multi-drop ethernet bus segments 508A, 508B, 508C, 524A, 524B, 524C, 534A, 534B, 534C reachable by the elevator controller 500, and a plurality of elevator system nodes 506A-506C, 520A-520F, 522A-522F, 526A-526C configured to communicate via the multi-drop ethernet bus segments 508A, 508B, 508C, 524A, 524B, 524C, 534A, 534B, 534C, wherein the elevator controller 500 is reachable by the elevator system nodes 506A-506C, 520A-520F, 522A-522F, 526A-526C via the multi-drop ethernet bus segments 508A, 508B, 508C, 524A, 524B, 524C, 534A, 534B, 534C.

In an example embodiment, the elevator communication system may comprise a point-to-point ethernet bus 510 and at least one connecting unit 502A, 502B comprising a first port connected to the multi-drop ethernet bus segment 508A, 508B and a second port connected to the point-to-point ethernet bus 510. Thus, by using the connecting units 502A, 502B one or more multi-drop ethernet bus segments 508A, 508B may be connected to the point-to-point ethernet bus 510. The connecting unit 502A, 502B may refer, for example, to a switch, a hub or a router. Further, the point-to-point ethernet bus 510 may be connected to the elevator controller 500. The point-to-point ethernet bus 510 may be, for example, 100BASE-TX or 10BASETIL point-to-point ethernet bus. The multi-drop ethernet bus s segments 508A, 508B may comprise, for example, 10BASE-T1S multi-drop ethernet bus.

In an example embodiment, an elevator system node 520A-520F, 522A-522F, 526A-526C may be configured to interface with at least one of an elevator fixture, an elevator sensor, an elevator safety device, and an elevator control device. Further, in an example embodiment, power to the nodes may be provided with the same cabling.

The elevator communication system may comprise an elevator safety controller. The elevator safety controller may be connected to the point-to-point ethernet bus 510 via a connecting unit 502E. This means that the elevator system nodes 506A-506C, 520A-520F, 522A-522F, 526A-526C may send information to the elevator safety controller 514 and vice versa via the common point-to-point ethernet bus 510. For example, the elevator system nodes 506A-506C, 520A-520F, 522A-522F, 526A-526C may send information, for example, from sensors or fixtures to the elevator controller 500 or the elevator safety controller 514 and receive information therefrom to control, for example, actuators configure fixtures etc. At least some of the elevator system nodes 506A-506C, 520A-520F, 522A-522F, 526A-526C may be safety nodes in accordance with IEC61508 SIL level 3, having a safety processing unit and a separate communication controller. Data of the safety processing unit may be sent only to the elevator safety controller 514. The safety nodes may be configured to interface with elevator safety devices, such as safety sensors or safety contacts indicating elevator safety, e.g. landing door contacts, door lock contacts, contact of overspeed governor, buffer contacts etc. The safety nodes may be configured to communicate with the elevator safety controller 514. To establish safe communication, different kind of data checks, such as checksums, error detection and/or correction algorithms etc. may be used in the communication.

The elevator communication system may further comprise an elevator drive 528 connected to the elevator controller 500. Further, the elevator communication system may comprise a network interface unit 518 communicatively connected to the elevator controller 500, the network interface unit 518 enabling a connection to an external communication network. The network interface unit 518 may comprise, for example, a router or a gateway.

The elevator communication system may further comprise a point-to-point ethernet bus 522 that provides a connection to an elevator car 516 and to various elements associated with the elevator car 516. The elevator car 516 may comprise a connecting unit 502D, for example, a switch, to which one or more elevator car nodes 526A, 526B, 526C may be connected. In an example embodiment, the elevator car nodes 526A, 526B, 526C can be connected to the connecting unit 502D via a multi-drop ethernet bus segment 508C, thus constituting an elevator car segment. In an example embodiment, the point-to-point-ethernet bus 522 is located in the travelling cable of the elevator car 516.

By implementing communication within the elevator communication system using at least one point-to-point ethernet bus and at least one multi-drop ethernet bus segment, various segments can be formed within the elevator communication system. For example, the elevator system nodes 520A, 520B may form a first landing segment, the elevator system nodes 520C, 520D may form a second landing segment, the elevator system nodes 520D, 520F may form a third landing segment, the shaft nodes 506A, 506B, 506C may form a first shaft segment, the shaft nodes 506D, 506E, 506F may form a second shaft segment, the elevator car nodes 526A, 526B, 526C may form an elevator car segment 508C, and the elevator drive 528 may form a machinery segment. Each of the segments 508A, 508B, 508C may be implemented using separate multi-drop ethernet buses.

As illustrated in FIG. 5B, the shaft nodes 506A, 506B, 506C may interconnect the shaft segment 508A to which the shaft nodes 506A, 506B, 506C are connected to and the landing segments 524A, 524B, 524C. In other words, the shaft nodes 506A, 506B, 506C may comprise or may act as a switch to the landing segments 524A, 524B, 524C. This may enable a simple solution for adding new elevator system nodes to the elevator communication system. This may also enable a solution in which a single elevator system node may act as a switch or a repeater to another multi-drop ethernet bus segment to which nearby elevator system elements, for example, a call button or buttons, a display or displays, a destination operating panel or panels, a camera or cameras, a voice intercom device etc.

The elevator communication system may further comprise a network analyzer configured to analyze bus traffic, the network analyzer being communicatively connected to the elevator controller.

In an example embodiment, one of more of the nodes 506A-506F, 520A-520F, 522A-522F, 526A-526C may act as a slave node or a master node.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator communication system, comprising:
a communication bus applying a master-slave protocol;
a master node connected to the communication bus;
at least one slave node connected to the communication bus;
wherein the master node and the at least one slave node are configured to apply, for data communication in the communication bus, a repeating frame structure in which a first time slot of a frame is reserved for the master node and in the remaining time slots of the frame each slave node of the at least one slave node has a dedicated time slot; and
wherein the master node is configured to extend the time between consecutive frames in order to enable a power saving mode for the communication bus.

2. The elevator communication system of claim 1, wherein the first time slot is preceded by a frame synchronization comprising idle bytes and a master node identifier byte, wherein the master node is configured to:
increase the number of idle bytes in the frame synchronization in order to enable the power saving mode.

3. The elevator communication system of claim 1, wherein the master node is configured to receive from an elevator controller a command to enter the power saving mode.

4. The elevator communication system of claim 1, wherein the at least one slave node is configured to:
enter the power saving mode when a duration between consecutive frames exceeds a predetermined threshold.

5. The elevator communication system of claim 1, wherein the master node is configured to:
read at least one of its safety inputs;
determine a change in at least one read safety input; and
re-initiate data communication via the communication bus in response to determining the change.

6. The elevator communication system of claim 1, wherein:
a slave node is configured to:
read at least one its safety input;
determine a change in at least one read safety input; and
transmit an indication associated with the change to the master node in order to re-initiate data communication via the communication bus; and
the master node is configured to:
re-initiate data communication via the communication bus in response to the indication.

7. The elevator communication system of claim 1, wherein the communication bus comprises an ethernet communication bus.

8. The elevator communication system of claim 7, wherein the ethernet communication bus comprises at least one of:
one or more point-to-point ethernet bus segments; or
one or more multi-drop ethernet bus segments.

9. The elevator communication system of claim 8, wherein the point-to-point ethernet bus segment comprises 100BASE-TX or 10BASETIL point-to-point ethernet bus segment, and the multi-drop ethernet bus segment comprises a 10BASE-TIS multi-drop ethernet bus segment.

10. An elevator system comprising the elevator communication system of claim 1.

11. A method comprising:
applying, by a master node and at least one slave node, a master-slave protocol in a communication bus between the master node and the at least one slave node, wherein the master node and the at least one slave node are configured to apply, for data communication in the communication bus, a repeating frame structure in which a first time slot of a frame is reserved for the master node and in the remaining time slots of the frame each slave node of the at least one slave node has a dedicated time slot; and
extending, by the master node, the time between consecutive frames in order to enable a power saving mode for the communication bus.

12. The method of claim 11, wherein the first time slot is preceded by a frame synchronization comprising idle bytes and a master node identifier byte, and the method further comprises:
increasing, by the master node, the number of idle bytes in the frame synchronization in order to enable the power saving mode.

13. The method of claim 11, further comprising:
receiving, by the master node, from an elevator controller a command to enter the power saving mode.

14. The method of claim 11, further comprising:
reading, by the master node, at least one its safety input;
determining, by the master node, a change in at least one read safety input; and
re-initiating, by the master node, data communication via the communication bus in response to determining the change.

15. The method of claim 11, further comprising:
reading, by a slave node, at least one its safety input;
determining, by the slave node, a change in at least one read safety input;
transmitting, by the slave node, an indication associated with the change to the master node in order to re-initiate data communication via the communication bus; and
re-initiating, by the master node, data communication via the communication bus in response to the indication.

16. A master node comprising:
means for applying a master-slave protocol in a communication bus between the master node and at least one slave node, wherein the master node and the at least one slave node are configured to apply, for data communication in the communication bus, a repeating frame structure in which a first time slot of a frame is reserved for the master node and in the remaining time slots of the frame each slave node of the at least one slave node has a dedicated time slot;
means for extending the time between consecutive frames in order to enable a power saving mode for the communication bus.

17. The master node of claim 16, wherein the first time slot is preceded by a frame synchronization comprising idle bytes and a master node identifier byte, and the master node comprises:
means for increasing the number of idle bytes in the frame synchronization in order to enable the power saving mode.

18. The master node of claim 16, wherein, the master node comprises:
means for receiving from an elevator controller a command to enter the power saving mode.

19. The master node of claim 16, wherein, the master node comprises:
means for reading at least one its safety input;
means for determining a change in at least one read safety input; and
means for re-initiating data communication via the communication bus in response to determining the change.

20. The master node of claim 16, wherein, the master node comprises:
means for receiving, from a slave node, an indication associated with a change of at least safety input of the slave node; and
means for re-initiating data communication via the communication bus in response to the indication.

21. A non-transitory computer readable medium storing a computer program comprising program code, which when executed a master node comprising:
means for applying a master-slave protocol in a communication bus between the master node and at least one slave node, wherein the master node and the at least one slave node are configured to apply, for data communication in the communication bus, a repeating frame structure in which a first time slot of a frame is reserved for the master node and in the remaining time slots of the frame each slave node of the at least one slave node has a dedicated time slot; and
means for extending the time between consecutive frames in order to enable a power saving mode for the communication bus, causes the master node to perform the method of claim 11.

22. A non-transitory computer-readable medium comprising a computer program comprising program code, which when executed a master node comprising:
means for applying a master-slave protocol in a communication bus between the master node and at least one slave node, wherein the master node and the at least one slave node are configured to apply, for data communication in the communication bus, a repeating frame structure in which a first time slot of a frame is reserved for the master node and in the remaining time slots of the frame each slave node of the at least one slave node has a dedicated time slot; and
means for extending the time between consecutive frames in order to enable a power saving mode for the communication bus, causes the master node to perform the method of claim 12.
